(19) United States
(12) Patent Application Publication
(10) Pub. No.: US 2026/0080368 A1
(43) Pub. Date: Mar. 19, 2026

(54) SCHEDULE SIGN-IN METHOD AND APPARATUS, DEVICE, AND MEDIUM

(71) Applicant: Beijing Zitiao Network Technology Co., Ltd., Beijing (CN)

(72) Inventors: Ke LI, Beijing (CN); Kang ZHENG, Beijing (CN); Shuying LI, Beijing (CN); Yuanyang LOU, Beijing (CN); Hong MA, Beijing (CN); Simin YANG, Beijing (CN); Xuemei DING, Beijing (CN); Chaofan YANG, Beijing (CN); Xingyu WANG, Beijing (CN); Yunjie HUO, Beijing (CN); Dongliang ZHAO, Beijing (CN)

(21) Appl. No.: 19/108,765

(22) PCT Filed: Nov. 20, 2023
(86) PCT No.: PCT/CN2023/132609

§ 371 Date: Mar. 5, 2025

(30) Foreign Application Priority Data
Dec. 28, 2022 (CN) 202211700049.9

(51) Int. Cl. G06Q 10/1093; G06F 9/54

(52) U.S. Cl. CPC G06Q 10/1093; G06F 9/542

(57) ABSTRACT

The present application discloses a schedule check-in method and apparatus, a device, and a medium. When a user creates a schedule, in response to a schedule creation operation triggered by the user on a calendar client, schedule-related information input by the user is acquired. The schedule-related information includes check-in information, and a check-in time in the check-in information is related to a time corresponding to a first schedule to be created. The first schedule with a check-in function is created based on the schedule-related information, so that the check-in function can be implemented through the first schedule. That is, with the technical solutions provided in the present application, a schedule with a check-in function may be created, and there is no need to use a separate questionnaire for check-in, which is convenient for users to check in and improves the user experience.

The present application claims priority to Chinese Patent Application No. 202211700049.9, filed with the China National Intellectual Property Administration on Dec. 28, 2022 and entitled “SCHEDULE SIGN-IN METHOD AND APPARATUS, DEVICE, AND MEDIUM”, which is hereby incorporated by reference in its entirety.

### FIELD

The present application relates to the field of computer technologies and, in particular, to a schedule check-in method and apparatus, a device, and a medium.

### BACKGROUND

In order to meet the meeting requirements in different scenarios, users may hold remote audio and video conferences through conference applications, so as to realize efficient meetings at any time and place. Before a meeting is held, check-in is usually required. At present, users usually use a form offline or a third-party questionnaire for check-in collection. However, the preceding check-in manners make the subsequent statistics time-consuming and labor-intensive, and the statistical efficiency is low.

### SUMMARY

In view of this, the present application provides a schedule check-in method and apparatus, a device, and a medium, so as to implement the correlation between check-in information and a schedule, which is convenient for users to check in and improves the work efficiency.

To achieve the preceding objectives, the technical solutions provided in the present application are as follows.

In a first aspect of the present application, a schedule check-in method is provided, including:
acquiring schedule-related information input by a user in response to a schedule creation operation triggered by the user on a target client, the schedule-related information including check-in information, a check-in time in the check-in information being related to a time corresponding to a first schedule to be created; and
creating the first schedule with a check-in function based on the schedule-related information.

In a second aspect of the present application, a schedule check-in apparatus is provided, including:
an obtaining unit, configured to acquire schedule-related information input by a user in response to a schedule creation operation triggered by the user on a target client, the schedule-related information including check-in information, a check-in time in the check-in information being related to a time corresponding to a first schedule to be created; and
a creation unit, configured to create the first schedule with a check-in function based on the schedule-related information.

In a fourth aspect of the present application, an electronic device is provided, including: a processor and a memory;
the memory is configured to store instructions or a computer program; and
the processor is configured to execute the instructions or the computer program in the memory to cause the electronic device to execute the method according to the first aspect.

In a fourth aspect of the present application, a computer-readable storage medium is provided, in which instructions are stored, and when the instructions are executed on a device, the device is caused to execute the method according to the first aspect.

In a fifth aspect of the present application, a computer program product is provided, including a computer program/instructions, and when the computer program/instructions are executed by a processor, the method according to the first aspect is implemented.

It can be seen that the present application has the following beneficial effects:

In the present application, when a user creates a schedule, in response to a schedule creation operation triggered by the user on a calendar client, schedule-related information input by the user is acquired. The schedule-related information includes check-in information, and a check-in time in the check-in information is related to a time corresponding to a first schedule to be created. The first schedule with a check-in function is created based on the schedule-related information, so that the check-in function can be implemented through the first schedule. That is, with the technical solutions provided in the present application, a schedule with a check-in function may be created, and there is no need to use a separate questionnaire for check-in, which is convenient for users to check in and improves the user experience.

### BRIEF DESCRIPTION OF THE DRAWINGS

In order to more clearly explain the technical solutions in the embodiments of the present application or in the prior art, the following will briefly introduce the drawings that need to be used in the description of the embodiments or the prior art. Obviously, the drawings in the following description are only some embodiments recorded in the present application, and for those of ordinary skill in the art, other drawings can be obtained based on these drawings without creative efforts.

FIG. 1 is a flowchart of a schedule check-in method provided by an embodiment of the present application.

FIG. 2a is a schematic diagram of a schedule creation page provided by an embodiment of the present application.

FIG. 2b is a schematic diagram of a check-in settings page provided by an embodiment of the present application.

FIG. 2c is a schematic diagram of a schedule creation page displaying a check-in time provided by an embodiment of the present application.

FIG. 3a is a schematic diagram of a check-in link in a first page provided by an embodiment of the present application.

FIG. 3b is a schematic diagram of a check-in QR code in a first page provided by an embodiment of the present application.

FIG. 3c is a schematic diagram of a first notification message provided by an embodiment of the present application.

FIG. 3d is a schematic diagram of a schedule details page provided by an embodiment of the present application.

FIG. 4a is a schematic diagram of modifying a first schedule provided by an embodiment of the present application.

FIG. 4b is a schematic diagram of a second notification message provided by an embodiment of the present application.

FIG. 4c is a schematic diagram of check-in data provided by an embodiment of the present application.

FIG. 5a is a schematic diagram of a multi-dimensional table for collecting check-in data provided by an embodiment of the present application.

FIG. 5b is a schematic diagram of a check-in form provided by an embodiment of the present application.

FIG. 5c is a schematic diagram of a multi-dimensional table corresponding to a repetitive schedule provided by an embodiment of the present application.

FIG. 6a is a schematic diagram of prompt information provided by an embodiment of the present application.

FIG. 6b is a schematic diagram of a third notification message provided by an embodiment of the present application.

FIG. 7 is a schematic diagram of a schedule check-in apparatus provided by an embodiment of the present application.

FIG. 8 is a schematic diagram of a structure of an electronic device provided by an embodiment of the present application.

### DETAILED DESCRIPTION OF EMBODIMENTS

In order to enable those skilled in the art to better understand the solutions of the present application, the technical solutions in the embodiments of the present application will be described clearly and completely below in conjunction with the drawings in the embodiments of the present application. Obviously, the described embodiments are only a part of the embodiments of the present application, rather than all of the embodiments. All other embodiments obtained by those of ordinary skill in the art based on the embodiments in the present application without creative efforts fall within the protection scope of the present application.

At present, before an online conference is held, a participant is usually required to check in. Usually, a form offline or a third-party questionnaire is used for check-in collection, and the collection in the form offline is time-consuming and labor-intensive and is very inefficient.

Based on this, a schedule check-in method provided by an embodiment of the present application notifies a participant to check in by creating a schedule with a check-in function, without the need to use a separate questionnaire for check-in, so that the conference check-in is more convenient.

In order to facilitate understanding of the technical solutions provided by the present application, the following will be described in conjunction with the drawings.

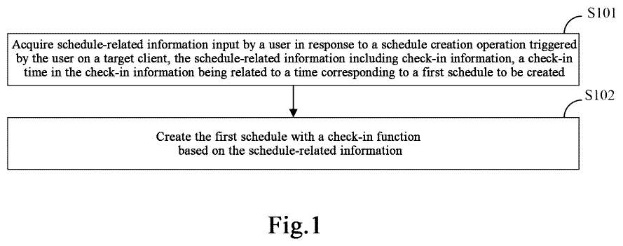

Referring to FIG. 1, which is a flowchart of a schedule check-in method provided by an embodiment of the present application, the method may be executed by a target client, and the target client may be installed in an electronic device. The electronic device may include devices with communication functions, such as a mobile phone, a tablet computer, a notebook computer, a desktop computer, a vehicle-mounted terminal, a wearable electronic device, an all-in-one computer, and a smart home device, or may be a device simulated by a virtual machine or an emulator. As shown in FIG. 1, the method may include the following steps.

S101: acquire schedule-related information input by a user in response to a schedule creation operation triggered by the user on a target client.

In this embodiment, in order to create a schedule, a user may trigger a schedule creation operation on an interface of a target client. After receiving the schedule creation operation triggered by the user, the target client acquires schedule-related information input by the user. The schedule-related information may include a title of the schedule, a participant in the schedule, a start time and an end time of the schedule, an attribute of the schedule (whether it is a repetitive schedule), and check-in information. The check-in information includes a check-in time, and the check-in time is related to a time corresponding to a first schedule to be created.

The check-in time may include a check-in start time and/or a check-in end time. Specifically, the check-in time being related to a time corresponding to the first schedule may include any of the following cases: the check-in time is before the first schedule starts, the check-in time is after the first schedule starts, and the check-in time is after the first schedule ends. During specific implementation, the check-in time may be a default check-in time, for example, the check-in time is 15 minutes before the schedule starts to the end time of the schedule, or the check-in time is customized by the user.

For example, the check-in start time may be set to any of the following cases:
before the first schedule starts: 5 minutes, 15 minutes, 30 minutes, and 60 minutes; after the first schedule starts: immediately, 5 minutes, 15 minutes, 30 minutes, and 60 minutes; after the first schedule ends: immediately, 5 minutes, 15 minutes, 30 minutes, and 60 minutes.

The check-in end time may be set to any of the following cases:
before the first schedule starts: 5 minutes, 15 minutes, 30 minutes, and 60 minutes; after the first schedule starts: immediately, 5 minutes, 15 minutes, 30 minutes, and 60 minutes; after the first schedule ends: immediately, 5 minutes, 15 minutes, 30 minutes, and 60 minutes.

It should be noted that the check-in end time needs to be later than the check-in start time. For example, if the check-in start time is set to 15 minutes before the first schedule starts, the check-in end time may not be 5 minutes before the schedule starts. For another example, if the first schedule is a 30-minute meeting, and the user sets the check-in to end immediately at the end of the first schedule, the check-in start time may not be 60 minutes after the first schedule starts.

The target client is a client of an application with a schedule creation function, and the schedule created in this embodiment refers to a schedule meeting. Specifically, the target client may be a client of an independent application or a client of a certain application in a collaborative office suite application. The collaborative office suite application is usually integrated with one or more of an instant messaging application, a schedule application, a task application, a cloud document application, an audio and video conference application, and the like.

In an embodiment of the present disclosure, acquiring the schedule-related information input by the user in response to the schedule operation triggered by the user on the target client includes: displaying a schedule creation page in response to the schedule operation triggered by the user on the target client; and acquiring the schedule-related information in response to an input operation triggered by the user on the schedule creation page. The schedule creation page may include multiple controls that may be set, such as a schedule title, a time, a participant, and a check-in time.

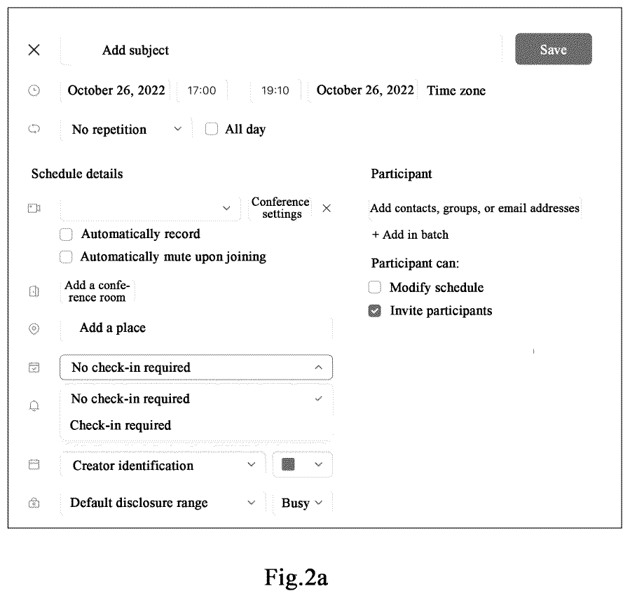

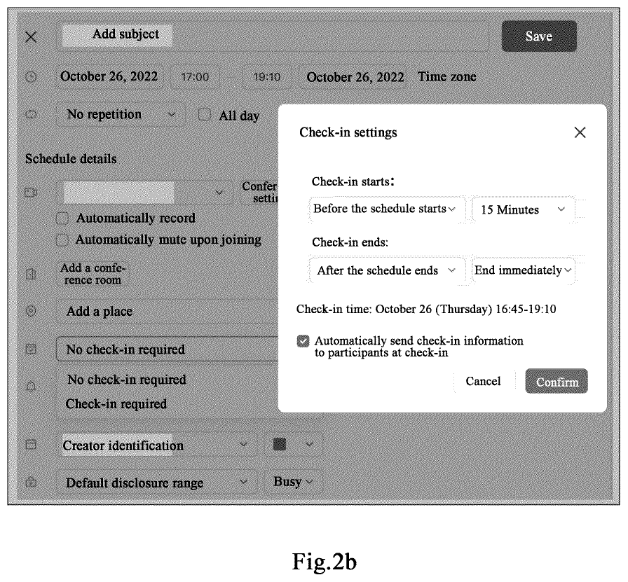

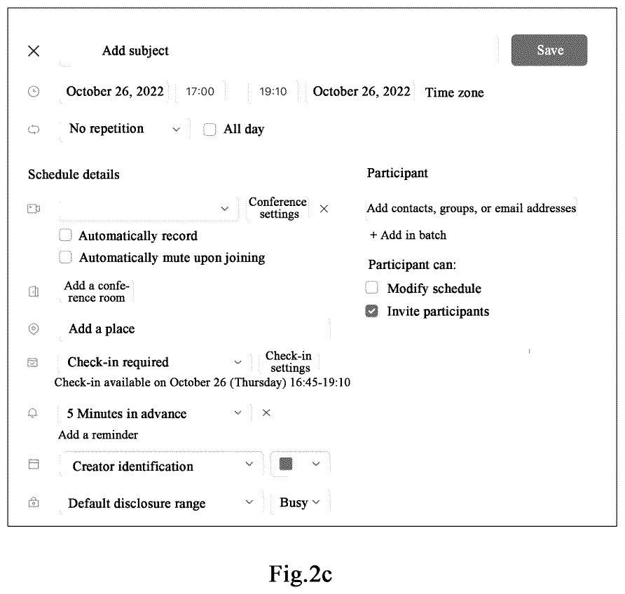

For example, on the schedule creation page as shown in FIG. 2a, a schedule subject, a schedule start time and an end time, schedule details, a participant, and the like may be set. In the schedule details, the user may set whether the created schedule requires check-in. If the user selects “check-in required”, a check-in settings pop-up window may be displayed to support settings such as a check-in time and a check-in place.

For example, on the check-in settings page as shown in FIG. 2b, the check-in settings page has a default check-in time: 15 minutes before the schedule starts to the end time of the schedule, and also supports custom setting of the time. When the user customizes the check-in time, a time before the schedule starts, a time after the schedule starts, and a time after the schedule ends may be selected as split points, and a time from the split points may also be selected. In addition, the user may also configure “whether to automatically send the check-in information to the participant at check-in” on the check-in settings page, and if the user selects the checkbox of this option, the check-in information will be sent to the participant at check-in using a calendar assistant. Generally, the preceding checkbox is not selected and is set by the user according to the requirements.

In some implementations, the user may also set a check-in place on the check-in settings page (not shown in FIG. 2b for the time being), and “Only check-ins near the specified place are valid” is checked by default. After the checking, a specific place may be added (a required item), and it is specified that “Participants may check in within the range of x meters from the check-in place”. If the “Only check-ins near the specified place are valid” is unchecked, the input box and description of the place to be added will not be displayed, and this item will no longer need to be filled in the check-in forms sent to the participants.

In some implementations, after completing the settings of the check-in time on the check-in settings page, the user returns to the schedule creation page. In this case, the check-in time is displayed on the schedule creation page. As shown in the schedule creation page in FIG. 2c, the check-in time is displayed under “Check-in settings”.

S102: create a first schedule with a check-in function based on the schedule-related information.

After the schedule-related information is acquired, the first schedule will be created according to the schedule-related information, and the first schedule has a check-in function.

After the creation of the first schedule is completed, the first schedule may be displayed on an interface of the target client, and a schedule details page corresponding to the first schedule is displayed in response to a trigger operation of the user on the first schedule displayed on the interface of the target client, and the schedule details page displays the schedule-related information corresponding to the first schedule.

In some embodiments of the present disclosure, if the check-in information includes first configuration information and a current time is the check-in time, a check-in notification message is sent to a participant in the first schedule. The first configuration information refers to that the user checks the option “Automatically send check-in information to the participant at check-in” when setting the check-in information. That is, when the user sets the first configuration information when setting the check-in information, the check-in notification message will be automatically sent to the participants of the first schedule after the first schedule reaches the check-in time, so that the participants can check in in time.

If the check-in information does not include the first configuration information, a check-in notification message is sent to a participant in the first schedule in response to a sending operation triggered by the user on the check-in information. That is, when the user does not set the first configuration information when setting the check-in information, the user (organizer) manually triggers to send the check-in notification message to the participants of the first schedule.

Sending the check-in notification message to the participant in the first schedule in response to the sending operation triggered by the user on the check-in information may include: displaying a first page in response to a trigger operation of the user on the check-in information, the first page including a check-in link and/or a check-in QR code; and sending the check-in notification message to the participant in the first schedule in response to a selection operation triggered by the user on the first page.

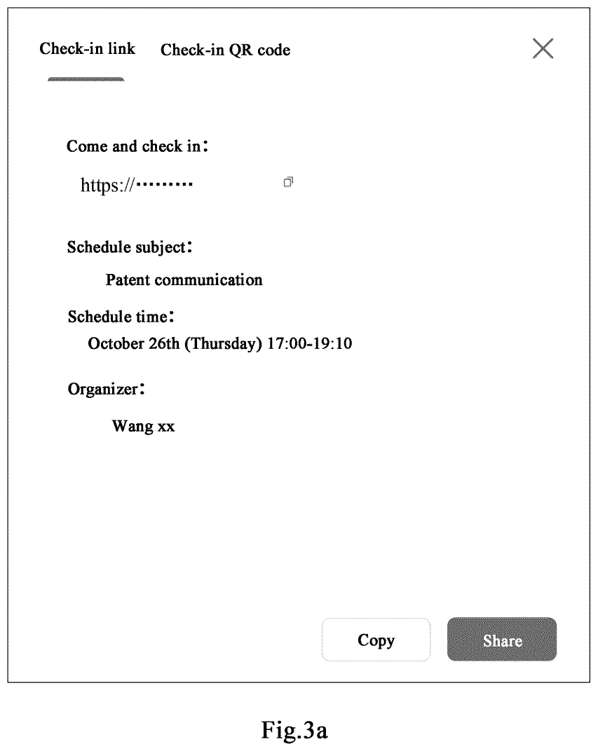

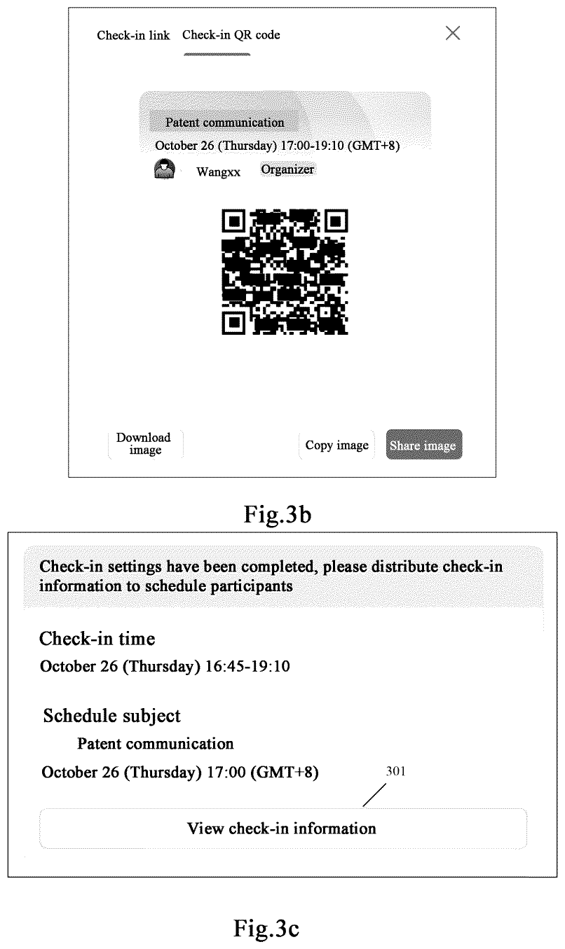

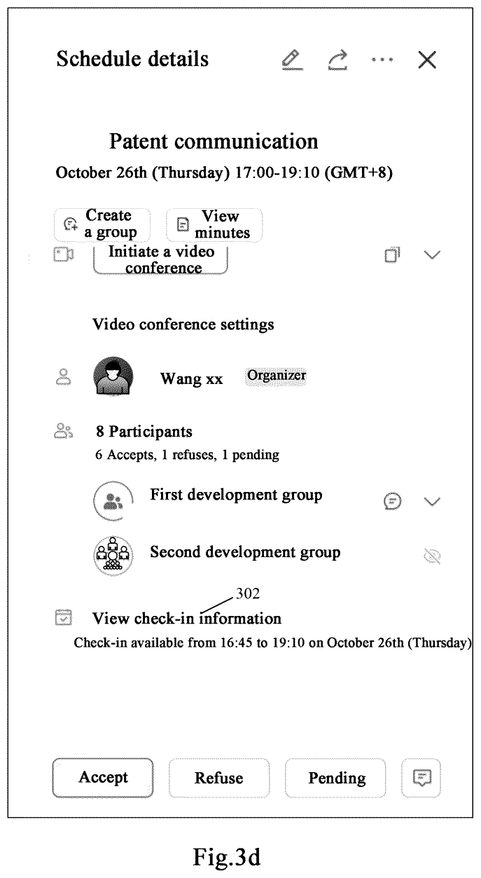

The check-in notification message includes a selected check-in manner, such as a check-in link or a check-in QR code. Specifically, the check-in link or the check-in QR code may include information such as a schedule subject, a schedule time, and a schedule organizer. For example, as shown in FIG. 3a, the first page displays two labels, a check-in link and a check-in QR code, and the user may switch between them arbitrarily. The display information corresponding to the check-in link is as shown in FIG. 3a, and the display information corresponding to the check-in QR code is as shown in FIG. 3b.

For the check-in link, the user may send the check-in link to the participants in the first schedule in the first page by copying or sharing, and the participants may complete the check-in by clicking the check-in link. After the user clicks to copy the check-in link, “Copy successful” may be prompted. For the check-in QR code, the user may send the check-in QR code to the participants in the first schedule in the first page by sharing the image, downloading the image, or copying the image. When the user sends the check-in QR code to the participants in the first schedule by sharing the image, a sharing page may be displayed in response to a trigger operation of the user on a sharing image control, and the user may select an object to be shared on the sharing page. After the user selects the object to be shared on the sharing page, a sending operation may be triggered on the sharing page, and the check-in QR code is sent to a chat of the sharing object in the form of a chat message.

The check-in QR code may be set as a non-expired QR code, and the use situation of the QR code is restricted by restricting the check-in time. Generally, one schedule corresponds to one check-in QR code (including repetitive schedules, but different repetitive schedules correspond to different check-in QR codes). For example, schedule 1 and schedule 2 are both repetitive schedules, but the check-in QR codes corresponding to the two repetitive schedules are different.

In an embodiment of the present disclosure, displaying the first page in response to a trigger operation of the user on the check-in information includes: displaying the first page in response to a trigger operation of the user on a first control in a first notification message or a second control in the first schedule. The first control and the second control are each used to view the check-in information of the first schedule, and the first notification message is sent by an assistant of the target client to the user (organizer) after the first schedule is created, and the first notification message is used to notify the user that the check-in settings for the first schedule have been completed.

Specifically, the first notification message may include information such as a message main title, a message subtitle, a check-in time, a schedule subject, a schedule time, and a first control. For example, as shown in the schematic diagram of the first notification message in FIG. 3c, the message main title is “Check-in settings have been completed”, the message subtitle is “Check-in information will be automatically sent to participants at check-in”, and the first control 301. The content displayed in the message subtitle is different in different cases. For example, when the check-in information includes the first configuration information, the message subtitle may be “Check-in information will be automatically sent to participants at check-in”; when the check-in information does not include the first configuration information, the message subtitle may be “Please distribute the check-in information to participants before check-in”.

The second control in the first schedule refers to the second control in the schedule details page corresponding to the first schedule. For example, as shown in the schematic diagram of the schedule details page in FIG. 3d, relevant information of the first schedule and the second control 302 are included.

It can be seen that when a user creates a schedule, in response to a schedule creation operation triggered by the user on a calendar client, schedule-related information input by the user is acquired. The schedule-related information includes check-in information, and a check-in time in the check-in information is related to a time corresponding to a first schedule to be created. The first schedule with a check-in function is created based on the schedule-related information, so that the check-in function can be implemented through the first schedule. That is, with the technical solutions provided in the present application, a schedule with a check-in function may be created, and there is no need to use a separate questionnaire for check-in, which is convenient for users to check in and improves the user experience.

In some embodiments of the present disclosure, the first schedule may also be modified from requiring check-in to not requiring check-in. Specifically, an edit page corresponding to the first schedule is displayed in response to an edit operation triggered by the user on the first schedule; and the first schedule is updated to a schedule that does not require check-in in response to an operation triggered by the user on the edit page to modify the first schedule to a schedule that does not require check-in.

Specifically, when the user modifies the first schedule from requiring check-in to not requiring check-in, the check-in time of the first schedule has already started, a confirmation page is displayed in response to the operation triggered by the user on the edit page to modify the first schedule to a schedule that does not require check-in; and the first schedule is updated to a schedule that does not require check-in in response to a confirmation operation triggered by the user on the confirmation page. The confirmation page is used to prompt the user to confirm that the first schedule is modified to a schedule that does not require check-in.

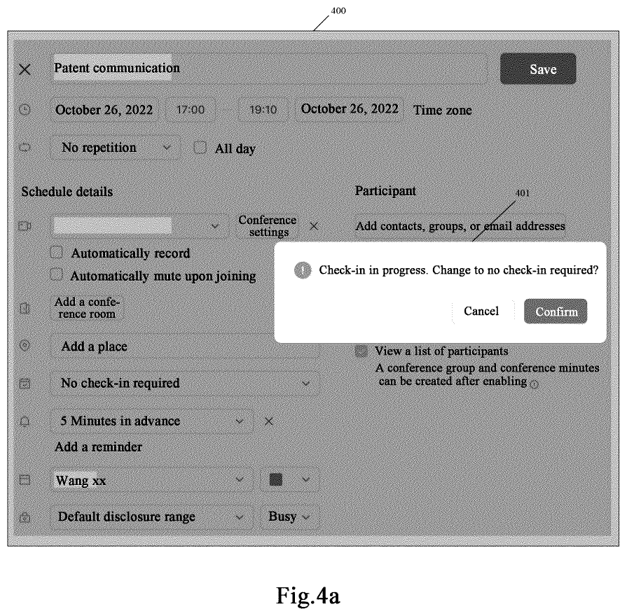

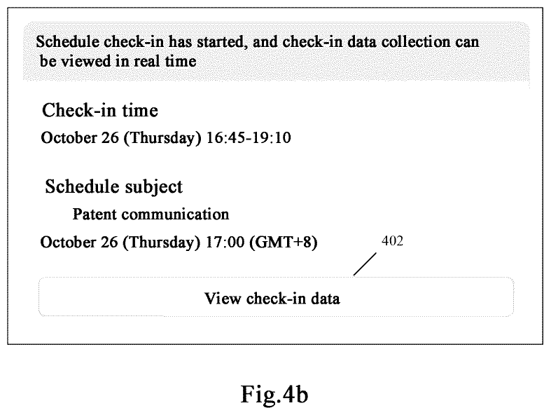

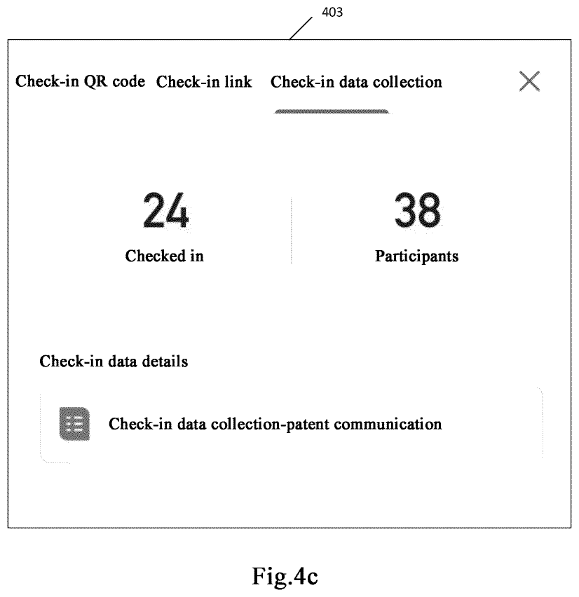

For example, as shown in the edit page 400 corresponding to the first schedule in FIG. 4a, the check-in is in progress, and the user modifies “Check-in settings” from “Check-in required” to “Check-in not required” in the edit page 400. When the user clicks the save control in the edit page 400, the confirmation page 401 may be displayed in the form of a pop-up window, so that the user confirms that the first schedule is modified to not require check-in.

In some embodiments of the present disclosure, when the check-in time starts, the assistant of the target client may send a message to the schedule organizer to remind check-in. Specifically, a second notification message is received, and the second notification message is used to prompt the user to view the check-in data. The second notification message may include: a message title, a check-in time, a schedule subject, and a third control. The third control is used to view the check-in data. The second notification message may be sent to the organizer in the form of a chat message and displayed in the chat box of the organizer in the form of a card.

For example, as shown in the schematic diagram of the second notification message in FIG. 4b, the message title is “Schedule check-in has started, and check-in data collection can be viewed in real time”, and the third control 402 is included. After the user clicks the third control 402, the user may jump to a page for collecting the check-in data to view the check-in data.

In some embodiments of the present disclosure, a second page is displayed in response to a trigger operation of the user on the check-in information, and the second page includes check-in data corresponding to the first schedule. Specifically, the user may display the second page by triggering the third control in the second notification message; or the user may display the second page by triggering the second control in the first schedule. The check-in data may include the number of real-time check-ins and the number of participants.

For example, as shown in the second page 403 in FIG. 4c, the number of check-ins, the number of participants, and an attachment including check-in data details may be displayed. The user may view the detailed check-in data by clicking the attachment. The attachment may be a table or a document.

The check-in data may include first check-in data and second check-in data. The first check-in data is used to collect check-in persons and check-in times corresponding to the check-in persons, and the second check-in data is used to collect participation information of participants in the first schedule. The first check-in data and the second check-in data may be in the same attachment or in different attachments. For example, the first check-in data and the second check-in data are in different worksheets of the same table, or the first check-in data and the second check-in data are in different tables. That is, with the check-in manner provided in this embodiment, detailed check-ins can be directly obtained, and there is no need to compare the questionnaire results with the schedule participants one by one to draw a conclusion, and the check-in location, check-in time, and the like of the participants may also be known, thereby improving the work efficiency.

The participation information includes one or more of: a participant identifier, an affiliated department, an invitation status, and a check-in status. The participant may be one or more of: a participant person invited to the first schedule, a person not invited to the first schedule but who checks in, and a person not invited to the first schedule, who does not check in, but who joins a meeting.

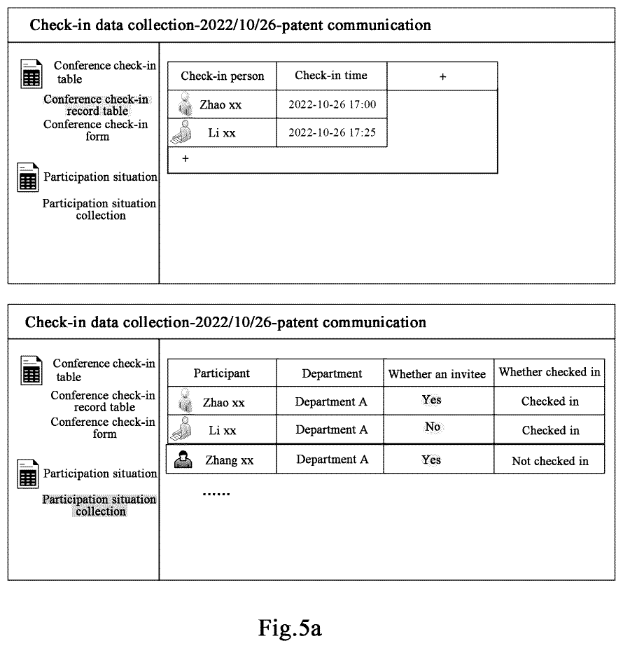

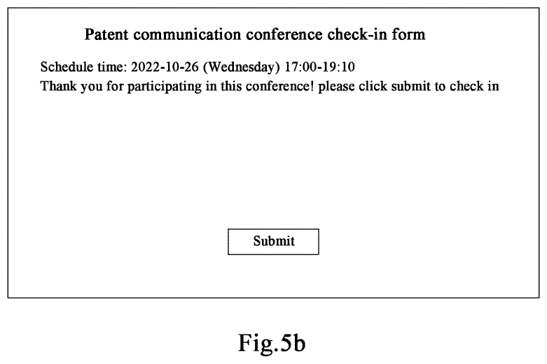

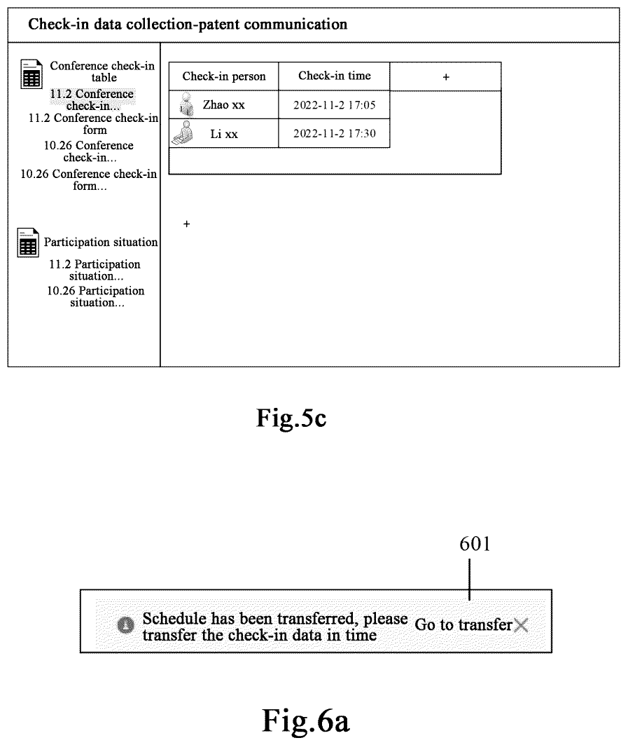

For example, as shown in the schematic diagram of the check-in data collection in FIG. 5a, the check-in data is carried by a multi-dimensional table. Specifically, the multi-dimensional table may include two data tables, one data table is a conference check-in table, and the other data table is a participation situation table. The conference check-in table may include a conference check-in record table and a conference check-in form. The conference check-in record table may include an identifier (avatar and name) of a check-in person and a check-in time, and the organizer may also add a field in the conference check-in record table. The conference check-in form includes information such as a schedule date, a schedule start time, and an end time. The participation situation table may include an identifier (avatar and name) of a participant, an affiliated department, whether the participant is an invitee (if the user is in the invitation list, it is [Yes]; if not, it is [No]), and whether the participant checks in (if the participant is in the check-in record table, “Checked in” is displayed; if not, it is “Not checked in”).

The specific representation of the conference check-in form is as shown in FIG. 5b, including a title “Patent communication conference check-in form”, a schedule time, and prompt information.

In some embodiments of the present disclosure, if the first schedule is a repetitive schedule, each time the first schedule is repeated, the check-in data corresponding to the first schedule is collected into different worksheets of the same table; or the check-in data corresponding to the first schedule is collected into the same worksheet, and the worksheet includes a filter field, and the filter field is used to screen check-in data corresponding to an ith execution of the first schedule.

Specifically, each time the first schedule is repeated, the check-in data corresponding to the current first schedule will be recorded, and the check-in data may be collected into the multi-dimensional table. The conference check-in table in the multi-dimensional table includes a conference check-in record table and a conference check-in form corresponding to each execution of the first schedule. The participation table includes a participation collection table corresponding to each execution of the first schedule. In order to distinguish the first schedule at different times, when displaying the conference check-in record table, the conference check-in form, and the participation collection table in the multi-dimensional table, a corresponding date may be displayed.

For example, as shown in FIG. 5c, the “Patent communication” schedule is a repetitive schedule, which is executed every Wednesday, and the check-in forms corresponding to each execution of the schedule may be displayed in the multi-dimensional table in chronological order. Specifically, the check-in forms are displayed in chronological order from near to far.

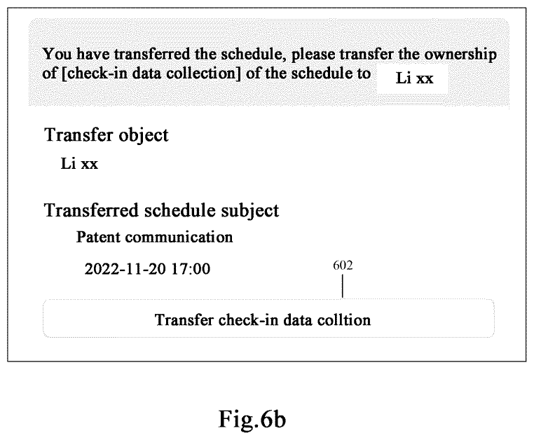

In some embodiments of the present disclosure, the organizer of the schedule may also transfer the ownership of the first schedule. Considering the security of the check-in data, the transfer of the check-in data will not be directly triggered when the schedule is transferred, but the transferor may be prompted to transfer the check-in data by sending prompt information. Specifically, prompt information is displayed in response to the user triggering transfer of the first schedule, and the prompt information is used to prompt the user to transfer the check-in data corresponding to the first schedule. Specifically, the user may trigger a schedule transfer operation on the schedule details page corresponding to the first schedule, and after the first schedule is transferred, a new banner may be added to prompt “Schedule has been transferred, please transfer the check-in data to the new schedule organizer”. The prompt information may also include a fourth control, through which the transfer of the check-in data may be triggered. For example, as shown in FIG. 6a, the prompt information includes the fourth control 601.

The original organizer may quit the first schedule or may be a participant in the first schedule after transferring the first schedule.

In some embodiments of the present disclosure, the third notification message is received in response to the user triggering transfer of the first schedule, and the third notification message is used to notify the user to transfer the check-in data corresponding to the first schedule. Specifically, after the original organizer transfers the first schedule, the target client may send the third notification message to the original organizer to notify the original organizer to transfer the check-in data. The third notification message may include a transfer object, a schedule subject, a transfer time, and a fifth control, and the fifth control may trigger the transfer of the check-in data. For example, as shown in the third notification message in FIG. 6b, the notification message may include a transfer object, a transferred schedule subject, a transfer time, and the fifth control 602.

Specifically, a third page is displayed in response to a trigger operation of the user on the check-in data, and the third page is used to transfer the check-in data corresponding to the first schedule. In response to a transfer operation triggered by the user on the transfer page, the check-in information and the check-in data are no longer displayed to the user (original organizer). Specifically, the user may trigger the fourth control 601 in FIG. 6a or the fifth control 602 in FIG. 6b to display the third page. After the transfer of the check-in data is completed, the fifth control in FIG. 6b is set to an ineffective state, and the corresponding display text may be updated to “Check-in data has been transferred”. After the transfer of the check-in data is completed, when the original organizer views the first schedule, the second control is no longer displayed in the schedule details page corresponding to the first schedule, and the check-in data of the first schedule cannot be viewed.

In some embodiments of the present disclosure, if the first schedule is a repetitive schedule and a check-in form corresponding to the first schedule is not transferred before a next execution of the first schedule, check-in data corresponding to a next execution of the first schedule is collected through a newly created check-in form in response to the next execution of the first schedule. That is, if the original organizer does not transfer the check-in data when executing the first schedule, the check-in data of the first schedule is collected by creating a new check-in form.

In some embodiments of the present disclosure, a second schedule is obtained in response to the user triggering copying of the first schedule, and the second schedule does not include check-in information set in the first schedule. That is, when the first schedule is copied, the check-in information corresponding to the first schedule is not copied, and the check-in settings of the second schedule are set to not require check-in by default.

In some embodiments of the present disclosure, if the first schedule is in progress, check-in may also be implemented in one or more of the following manners:

One manner is displaying a fourth page for check-in in response to an operation triggered by a participant on a progress page corresponding to the first schedule. Specifically, when the first schedule is in progress, the schedule organizer may initiate check-in (whether the identity is a host or a co-host), and find the “Check-in” application in “More” at the bottom of the conference page. The participant may click “Check-in” to display a check-in form, and check-in is implemented through the check-in form. The check-in form filled in by the online participant does not need to consider the geographical location, and “Online check-in” may be displayed.

Another manner is displaying a fifth page to prompt a participant to check in in response to a trigger operation of the user on the progress page corresponding to the first schedule if the first schedule is in progress. Specifically, when the first schedule is in progress, the schedule organizer may initiate check-in, and a fifth page is displayed in response to the check-in operation initiated by the schedule organizer. The fifth page may include a check-in control, and the participant completes check-in by triggering the check-in control in the fifth page.

The check-in pop-up window (fifth page) is automatically closed after the participant completes check-in/clicks to ignore/clicks to close the pop-up window/the pop-up window is displayed for more than three minutes. If the participant has completed check-in once, a reminder that the number of check-ins has reached the limit will be displayed when the check-in control is clicked again, and no further check-in is allowed. If the participant quits the conference and enters again, the check-in pop-up window will only be displayed for users who have not completed check-in.

Based on the preceding method embodiments, the embodiments of the present application provide a schedule check-in apparatus and an electronic device, which will be described below with reference to the drawings.

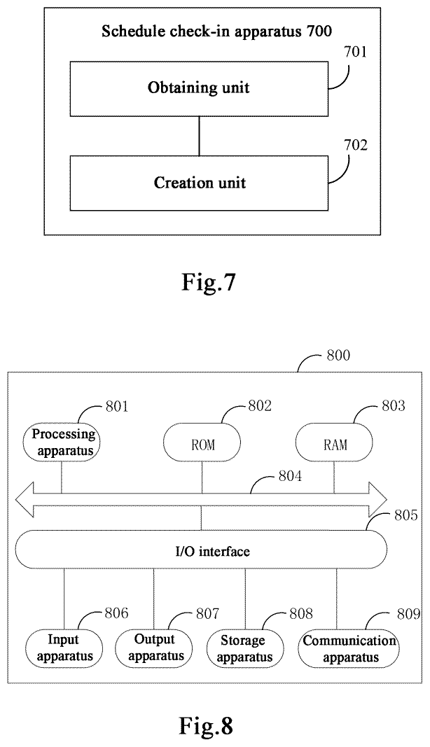

Referring to FIG. 7, which is a structure diagram of a schedule check-in apparatus provided by an embodiment of the present application, as shown in FIG. 7, the schedule check-in apparatus 700 may include: an obtaining unit 701 and a creation unit 702.

The obtaining unit 701 is configured to acquire schedule-related information input by a user in response to a schedule creation operation triggered by the user on a target client, the schedule-related information including check-in information, a check-in time in the check-in information being related to a time corresponding to a first schedule to be created.

The creation unit 702 is configured to create the first schedule with a check-in function based on the schedule-related information.

In some implementations, the check-in time includes one of before the first schedule starts, after the first schedule starts, and after the first schedule ends.

In some implementations, the apparatus further includes: a sending unit; the sending unit is configured to if the check-in information includes first configuration information and a current time is the check-in time, send a check-in notification message to a participant in the first schedule; or if the check-in information does not include the first configuration information, send a check-in notification message to a participant in the first schedule in response to a sending operation triggered by the user on the check-in information.

In some implementations, the sending unit includes a display sub-unit and a sending sub-unit;
the display sub-unit is configured to display a first page in response to a trigger operation of the user on the check-in information, the first page including a check-in link and/or a check-in QR code; and
the sending sub-unit is configured to send the check-in notification message to the participant in the first schedule in response to a selection operation triggered by the user on the first page, the check-in notification message including a selected check-in manner.

In some implementations, the display sub-unit is specifically configured to display the first page in response to a trigger operation of the user on a first control in a first notification message or a second control in the first schedule, the first control and the second control each being used to view the check-in information of the first schedule, and the first notification message being sent after the first schedule is created and used to notify the user that the check-in settings for the first schedule have been completed.

In some implementations, the apparatus further includes: a display unit; and
the display unit is configured to display the check-in time on a schedule creation page corresponding to the first schedule in response to the check-in information settings being completed by the user.

In some implementations, the apparatus further includes: a display unit and an update unit;
the display unit is configured to display an edit page corresponding to the first schedule in response to an edit operation triggered by the user on the first schedule; and
the update unit is configured to update the first schedule to a schedule that does not require check-in in response to an operation triggered by the user on the edit page to modify the first schedule to a schedule that does not require check-in.

In some implementations, the apparatus further includes: a receiving unit;
the receiving unit is configured to receive a second notification message, the second notification message being used to prompt the user to view check-in data.

In some implementations, the apparatus further includes: a display unit;
the display unit is configured to display a second page in response to a trigger operation of the user on the check-in information, the second page including check-in data corresponding to the first schedule.

In some implementations, if the first schedule is in progress, the check-in data includes the number of participants and the number of real-time check-ins persons.

In some implementations, the check-in data includes first check-in data and second check-in data, the first check-in data is used to collect check-in persons and check-in times corresponding to the check-in persons, and the second check-in data is used to collect participation information of a participant in the first schedule.

In some implementations, the participation information includes one or more of: a participant identifier, an affiliated department, an invitation status, and a check-in status.

In some implementations, the participant includes one or more of:
a participation person invited to the first schedule;
a person not invited to the first schedule but who checks in; and
a person not invited to the first schedule, who does not check in, but who joins a meeting.

In some implementations, if the first schedule is a repetitive schedule, the check-in data corresponding to the first schedule is collected into different worksheets of the same table each time the first schedule is repeated; or the check-in data corresponding to the first schedule is collected into the same worksheet, and the worksheet includes a filter field, and the filter field is used to screen check-in data corresponding to an ith execution of the first schedule.

In some implementations, the apparatus further includes: a display unit and/or a receiving unit;
the display unit is configured to display prompt information to prompt the user to transfer the check-in data corresponding to the first schedule in response to the user triggering transfer of the first schedule; and
the receiving unit is configured to receive a third notification message for notifying the user to transfer the check-in data corresponding to the first schedule in response to the user triggering transfer of the first schedule.

In some implementations, the display unit is specifically configured to display a third page for transferring the check-in data corresponding to the first schedule in response to a trigger operation of the user on the check-in data; and stop displaying the check-in information and the check-in data to the user in response to a transfer operation triggered by the user on the transfer page.

In some implementations, the apparatus further includes: a processing unit;
the processing unit is configured to if the first schedule is a repetitive schedule and a check-in form corresponding to the first schedule is not transferred before a next execution of the first schedule, collect check-in data corresponding to a next execution of the first schedule through a newly created check-in form in response to the next execution of the first schedule.

In some implementations, the obtaining unit 701 is further configured to obtain a second schedule in response to the user triggering copying of the first schedule, and the second schedule does not include check-in information set in the first schedule.

In some implementations, the apparatus further includes: a display unit;
the display unit is configured to, if the first schedule is in progress, display a fourth page for check-in in response to a trigger operation of a participant on a progress page corresponding to the first schedule; or if the first schedule is in progress, display a fifth page for prompting the participant to check in in response to a trigger operation of the user on a progress page corresponding to the first schedule.

It should be noted that, for the specific implementation of each unit in this embodiment, reference may be made to the related description in the above method embodiments. The division of units in the embodiments of the present application is schematic, and is only a logical function division, and in actual implementation, there may be other division methods. The functional units in the embodiments of the present application may be integrated into one processing unit, or each unit may exist physically alone, or two or more units may be integrated into one unit. For example, in the above embodiments, the processing unit and the sending unit may be the same unit or different units. The above integrated units may be implemented in the form of hardware or software functional units.

Referring to FIG. 8, it shows a schematic structural diagram of an electronic device 800 suitable for implementing the embodiments of the present disclosure. The terminal device in the embodiments of the present disclosure may include, but is not limited to, mobile terminals such as a mobile phone, a notebook computer, a digital broadcast receiver, a PDA (Personal Digital Assistant), a PAD (tablet computer), a PMP (Portable Multimedia Player), a vehicle-mounted terminal (such as a vehicle navigation terminal), and fixed terminals such as a digital TV and a desktop computer. The electronic device shown in FIG. 8 is only an example, and should not bring any limitation to the functions and scope of use of the embodiments of the present disclosure.

As shown in FIG. 8, the electronic device 800 may include a processing apparatus (such as a central processing unit, a graphics processing unit, etc.) 801 that may perform various appropriate actions and processing according to a program stored in a read-only memory (ROM) 802 or a program loaded from a storage apparatus 808 into a random access memory (RAM) 803. In the RAM 803, various programs and data required for the operation of the electronic device 800 are also stored. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the illustrated apparatuses. It may be an alternative to implement or provide more or fewer apparatuses.

In particular, according to the embodiments of the present disclosure, the processes described above with reference to the flowcharts may be implemented as a computer software program. For example, an embodiment of the present disclosure includes a computer program product, which includes a computer program carried on a non-transitory computer-readable medium, and the computer program contains program codes for executing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the preceding functions defined in the methods of the embodiments of the present disclosure are executed.

The electronic device provided by the embodiment of the present disclosure belongs to the same inventive concept as the method provided by the preceding embodiments. For the technical details not described in detail in this embodiment, reference may be made to the preceding embodiments, and this embodiment has the same beneficial effects as the preceding embodiments.

An embodiment of the present disclosure provides a computer storage medium on which a computer program is stored, and when the program is executed by a processor, the method provided in the preceding embodiments is implemented.

It should be noted that the preceding computer-readable medium in the present disclosure may be a computer-readable signal medium or a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier, in which computer-readable program codes are carried. The data signal propagated in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to: a wire, an optical cable, a radio frequency (RF), etc., or any suitable combination thereof.

In some implementations, the client and the server may communicate using any currently known or future-developed network protocol, such as the Hypertext Transfer Protocol (HTTP), and may interconnect with digital data communication (for example, a communication network) in any form or medium. Examples of the communication network include a local area network (“LAN”), a wide area network (“WAN”), the Internet, and an end-to-end network (for example, an ad hoc end-to-end network), as well as any currently known or future-Developed network.

The preceding computer-readable medium may be included in the preceding electronic device or may exist alone without being assembled into the electronic device.

The preceding computer-readable medium carries one or more programs, and when the one or more programs are executed by the electronic device, the electronic device is enabled to execute the preceding method.

The computer program codes for performing the operations of the present disclosure may be written in one or more programming languages or a combination thereof. The preceding programming languages include but are not limited to object-oriented programming languages such as Java, Smalltalk, C++, and also include conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In the case where the remote computer is involved, the remote computer may be connected to the user computer through any kind of network, including a local area network (LAN) or a wide area network (WAN), or may be connected to an external computer (for example, connected via the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of a unit/module is not intended to limit the unit in a certain circumstance.

The functions described herein above may be executed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that the various embodiments in this specification are described in a progressive manner, and each embodiment focuses on the differences from other embodiments, and the same or similar parts between the embodiments may be referred to each other. For the systems or apparatuses disclosed in the embodiments, since they correspond to the methods disclosed in the embodiments, the description is relatively simple, and reference may be made to the description of the methods for the related parts.

It should be understood that in the present application, “at least one” means one or more, and “multiple” means two or more. “And/or” is used to describe the association relationship of associated objects, indicating that three relationships may exist. For example, “A and/or B” may mean that only A exists, only B exists, and both A and B exist at the same time, where A and B may be singular or plural. The character “/” generally means that the associated objects before and after are in an “or” relationship. “At least one of the following” or similar expressions refer to any combination of these items, including any combination of a single item or multiple items. For example, at least one of a, b, or c may mean: a, b, c, “a and b”, “a and c”, “b and c”, or “a and b and c”, where a, b, and c may be single or plural.

It should be further noted that, in the present disclosure, the relational terms such as first and second are only used to distinguish one entity or operation from another entity or operation, and do not necessarily require or imply that there is any such actual relationship or order between these entities or operations. Moreover, the terms “include/include” or any other variants thereof are intended to cover non-exclusive inclusion, so that a process, method, article, or device including a series of elements not only includes those elements, but also includes other elements that are not explicitly listed, or elements that are inherent to such process, method, article, or device. Without further limitations, the elements defined by the statement “include/include one.” do not exclude the presence of other identical elements in the process, method, article, or device including the elements.

The steps of the methods or algorithms described in conjunction with the embodiments disclosed herein may be implemented directly with hardware, software modules executed by a processor, or a combination thereof. The software modules may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Therefore, the present application will not be limited to these embodiments shown herein, but is to be accorded the widest scope consistent with the principles and novel features disclosed herein.

1. A schedule check-in method, comprising:
acquiring schedule-related information input by a user in response to a schedule creation operation triggered by the user on a target client, the schedule-related information comprising check-in information, a check-in time in the check-in information being related to a time corresponding to a first schedule to be created; and
creating the first schedule with a check-in function based on the schedule-related information.

2. The method according to claim 1, wherein the check-in time comprises one of:
before the first schedule starts, after the first schedule starts, or after the first schedule ends.

3. The method according to claim 1, further comprising:
if the check-in information comprises first configuration information and a current time is the check-in time, sending a check-in notification message to a participant in the first schedule; or
if the check-in information does not comprise the first configuration information, sending a check-in notification message to a participant in the first schedule in response to a sending operation triggered by the user on the check-in information.

4. The method according to claim 3, wherein sending the check-in notification message to the participant in the first schedule in response to the sending operation triggered by the user on the check-in information comprises:
displaying a first page in response to a trigger operation of the user on the check-in information, the first page comprising a check-in link and/or a check-in QR code; and
sending the check-in notification message to the participant in the first schedule in response to a selection operation triggered by the user on the first page, the check-in notification message comprising a selected check-in manner.

5. The method according to claim 4, wherein displaying the first page in response to the trigger operation of the user on the check-in information comprises:
displaying the first page in response to a trigger operation of the user on a first control in a first notification message or a second control in the first schedule, the first control and the second control each being configured to view the check-in information of the first schedule, and the first notification message being sent after the first schedule is created and configured to notify the user that check-in settings for the first schedule have been completed.

6. The method according to claim 1, further comprising:
displaying the check-in time on a schedule creation page corresponding to the first schedule in response to the check-in information settings being completed by the user.

7. The method according to claim 1, further comprising:
displaying an edit page corresponding to the first schedule in response to an edit operation triggered by the user on the first schedule; and
updating the first schedule to a schedule that does not require check-in in response to an operation triggered by the user on the edit page to modify the first schedule to a schedule that does not require check-in.

8. The method according to claim 1, further comprising:
receiving a second notification message, the second notification message being configured to prompt the user to view check-in data.

9. The method according to claim 1, further comprising:
displaying a second page in response to a trigger operation of the user on the check-in information, the second page comprising check-in data corresponding to the first schedule.

10. The method according to claim 9, wherein if the first schedule is in progress, the check-in data comprises a number of participants and a number of real-time check-in persons.

11. The method according to claim 9, wherein the check-in data comprises first check-in data and second check-in data, the first check-in data is configured to collect check-in persons and check-in times corresponding to the check-in persons, and the second check-in data is configured to collect participation information of a participant in the first schedule.

12. The method according to claim 11, wherein the participation information comprises one or more of:
a participant identifier, an affiliated department, an invitation status, or a check-in status.

13. The method according to claim 10, or wherein the participant comprises one or more of:
a participation person invited to the first schedule;
a person not invited to the first schedule but who checks in; or
a person not invited to the first schedule, who does not check in, but who joins a meeting.

14. The method according to claim 9, wherein if the first schedule is a repetitive schedule, the check-in data corresponding to the first schedule is collected into different worksheets of the same table each time the first schedule is repeated; or the check-in data corresponding to the first schedule is collected into the same worksheet, the worksheet comprises a filter field, and the filter field is configured to screen check-in data corresponding to an ith execution of the first schedule.

15. The method according to claim 1, further comprising one or more of:
displaying a prompt message to prompt the user to transfer check-in data corresponding to the first schedule in response to the user triggering transfer of the first schedule; or
receiving a third notification message for notifying the user to transfer check-in data corresponding to the first schedule in response to the user triggering transfer of the first schedule.

16. The method according to claim 15, further comprising:
displaying a third page for transferring the check-in data corresponding to the first schedule in response to a trigger operation of the user on the check-in data; and
stopping displaying the check-in information and the check-in data to the user in response to a transfer operation triggered by the user on the transfer page.

17. The method according to claim 15, further comprising:
if the first schedule is a repetitive schedule and a check-in form corresponding to the first schedule is not transferred before a next execution of the first schedule, collecting check-in data corresponding to the next execution of the first schedule through a newly created check-in form in response to the next execution of the first schedule.

18. The method according to claim 1, further comprising:
obtaining a second schedule in response to the user triggering copying of the first schedule, the second schedule not comprising check-in information set in the first schedule.

19. (canceled)

20. (canceled)

21. An electronic device, comprising: a processor and a memory; wherein,
the memory is configured to store instructions or a computer program; and
the processor is configured to execute the instructions or the computer program in the memory to cause the electronic device to:
acquire schedule-related information input by a user in response to a schedule creation operation triggered by the user on a target client, the schedule-related information comprising check-in information, a check-in time in the check-in information being related to a time corresponding to a first schedule to be created; and
create the first schedule with a check-in function based on the schedule-related information.

22. A non-transitory computer-readable storage medium, storing instructions thereon, wherein when the instructions are executed on a device, the device is caused to:
acquire schedule-related information input by a user in response to a schedule creation operation triggered by the user on a target client, the schedule-related information comprising check-in information, a check-in time in the check-in information being related to a time corresponding to a first schedule to be created; and
create the first schedule with a check-in function based on the schedule-related information.
